(19) United States
(12) Patent Application Publication
(10) Pub. No.: US 2026/0246588 A1
(43) Pub. Date: Aug. 20, 2026

(54) NEW RADIO (NR) DOWNLINK (DL) INTERFERENCE ESTIMATION FOR SPECTRUM SHARING

(71) Applicant: Telefonaktiebolaget LM Ericsson (publ), Stockholm (SE)

(72) Inventors: Hong REN, Kanata (CA); Yongquan QIANG, Ottawa (CA); Wei WANG, Kanata (CA)

(73) Assignee: Telefonaktiebolaget LM Ericsson (publ), Stockholm (SE)

(21) Appl. No.: 19/118,768

(22) PCT Filed: Nov. 2, 2022
(86) PCT No.: PCT/IB2022/060555

§ 371 Date: Apr. 6, 2025

(51) Int. Cl. H04L 5/00; H04W 72/23

(52) U.S. Cl. CPC H04L 5/0051; H04W 72/23

(57) ABSTRACT

A method, network node and wireless device (WD) for improved New Radio (NR) downlink (DL) interference estimation for spectrum sharing are disclosed. According to one aspect, a method in a network node includes configuring New Radio (NR) demodulation reference signals (DMRSs) for physical downlink shared channel (PDSCH) with DMRS configuration type 2 in a first set of at least one orthogonal frequency division multiplexing (OFDM) symbol of a time slot, the at least one OFDM symbol being a symbol which contains Long Term Evolution (LTE) cell specific reference signals (CRSs). The method also includes transmitting the NR DMRS with configuration type 2 in the at least one OFDM symbol.

### TECHNICAL FIELD

The present disclosure relates to wireless communications, and in particular, to NewRadio (NR) downlink (DL) interference estimation for spectrum sharing.

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WD), as well as communication between network nodes and between WDs. Sixth Generation (6G) wireless communication systems are also under development.

### LTE/NR Spectrum Sharing

Wireless operators around the world have already started to deploy the latest technology, NR (Next Radio). When NR penetration is low at the beginning of the deployment, allocating a dedicated spectrum to NR can be a waste of radio resources when the spectrum can't be fully utilized by NR. Spectrum sharing provides the capability to allow NR and LTE to share the same spectrum. It enables operators to introduce NR while serving LTE users in the same spectrum. FIG. 1 illustrates one option of spectrum sharing. In this case, radio resources are dynamically allocated to NR and LTE in each subframe (with duration of 1 msec).

### LTE Cell-Specific Reference Signal

An LTE cell-specific reference signal (CRS) is used for a wireless device (WD) to derive channel state information. It is also used by the WD to perform PDSCH (Physical Downlink Shared Channel) demodulation. It is an always-on signal and is transmitted in every subframe. With 2 LTE CRS antenna ports, LTE CRS is transmitted in orthogonal frequency division multiplexed (OFDM) symbols 0, 4, 7 and 11. With 4 LTE CRS antenna ports, LTE CRS is transmitted in OFDM symbols 0, 1, 4, 7, 8 and 11.

### NR PDSCH Demodulation Reference Signal

A NR PDSCH demodulation reference signal (DMRS) is used by a WD to help the demodulation of the PDSCH data. The WD derives the downlink channel and interference estimation from PDSCH DMRS and uses the estimated channel and interference information to demodulate the corresponding PDSCH.

NR PDSCH DMRS may be in configuration type 1 or configuration type 2. FIG. 2 shows the single-symbol DMRS in configuration type 1 and configuration type 2.

For PDSCH DMRS configuration type 1, there are 2 CDM (Code Division Multiplexing) groups for the single-symbol DMRS. Each group occupies 6 sub-carriers of a resource block (RB). For configuration type 2 DMRS, there are 3 CDM groups for the single-symbol DMRS. Each group occupies 4 sub-carriers of a resource block (RB). In both cases, each CDM group supports 2 DMRS ports.

### NR DMRS Configuration for Spectrum Sharing

With spectrum sharing, NR and LTE share the same spectrum. To avoid collision with LTE CRS, NR PDSCH DMRS is normally transmitted in different OFDM symbols. For example, for NR PDSCH mapping type A, DMRS is transmitted in OFDM symbols 3 and 12 with single-symbol DMRS and one additional position. There is no LTE CRS in symbols 3 and 12.

### MMSE/IRC Equalizer at WD Side

At the WD, a MMSE (Minimum Mean Square Error)/IRC (Interference Rejection Combining) equalizer is usually used to demodulate signals transmitted on PDSCH to achieve better receiver performance. This is expressed by:

$$\hat{x} = {{H}^{H} ( H {H}^{H} + Q )}^{- I} y$$

where:
y—WD received signal on PDSCH before equalizer, including transmitted signals, interference and noise;
H—Effective channel matrix estimated based on DMRS;
Q—Interference and noise covariance matrix estimated based on DMRS; and
\hat{x}—Demodulated signals with MMSE/IRC equalizer, the inter-layers interference as well as inter-cell interference are mitigated.

When LTE CRS and NR DMRS are transmitted in different symbols, it may cause interference estimation issues for some WDs. Consider an NR WD that sees strong inter-cell interference from neighbor cells. When neighbor cells don't have much user traffic, the interference is mainly from LTE CRS. If the PDSCH DMRS for an NR WD is transmitted in symbols 3 and 12, the DMRS doesn't see any interference from neighbor's LTE CRS even though the interference may be very strong. In this case, the interference estimation obtained based on DMRS may have large error and the PDSCH performance may be impacted.

### SUMMARY

Some embodiments advantageously provide methods, network nodes, and wireless devices for New Radio (NR) downlink (DL) interference estimation for spectrum sharing that may be improved as compared with other arrangements.

Some embodiments allow LTE CRS and NR PDSCH DMRS to be transmitted in the same symbol while avoiding collision between them for the serving NR and LTE cells. By doing so, NR PDSCH DMRS may see inter-cell interference even when the interference is mainly from a neighbor's LTE CRS, which results in better interference estimation and better downlink performance.

With spectrum sharing, the conventional way to avoid collision between LTE CRS and NR DMRS is to place NR DMRS in symbols which don't contain LTE CRS. This may cause DL performance issue for some WDs, as described above.

Some embodiments include one or more of the following components:
When NR DMRS are in multiple OFDM symbols, NR DMRS and LTE CRS may be allowed to share some symbols while trying to avoid collision between them for the serving NR and LTE cells. In other symbols, NR DMRS doesn't share with LTE CRS;
Use DMRS configuration type 2 instead of configuration type 1;
Select certain DMRS additional positions;
Restrict the CDM groups and allows only one CDM group It further comprises at WD side; and/or.
Apply the proper interference and noise covariance (Q) matrix for demodulation of different resource elements (REs).

Some embodiments improve NR downlink performance for WDs that see strong interference from neighbor's LTE CRS in case of spectrum sharing.

According to one aspect, a method in a network node configured to communicate with a wireless device, WD, is provided. The method includes configuring New Radio, NR, demodulation reference signals, DMRSs, for physical downlink shared channel, PDSCH, with DMRS configuration type 2 in a first set of at least one orthogonal frequency division multiplexing, OFDM, symbol of a time slot, the at least one OFDM symbol being a symbol which contains Long Term Evolution, LTE, cell specific reference signals, CRSs. The method also includes transmitting the NR DMRS with configuration type 2 in the at least one OFDM symbol.

According to this aspect, in some embodiments, the method includes configuring DMRS for PDSCH with mapping type A with DMRS configuration type. In some embodiments, the at least one OFDM symbol includes symbols 7 and 11 of the time slot, the time slot having 14 OFDM symbols. In some embodiments, the at least one OFDM symbol includes symbol 8 of the time slot when the LTE CRS has 4 ports and there are three additional DMRS positions, the time slot having 14 OFDM symbols. In some embodiments, the NR DMRS with configuration type 2 and the LTE CRS are transmitted on different subcarriers in the at least one OFDM symbol. In some embodiments, the method includes: determining a DMRS code division multiplex, CDM, group that avoids collisions between the NR DMRS configuration type 2 and the LTE CRS; and signaling the WD with one or more DMRS ports that belong to the determined DMRS CDM group. In some embodiments, the method includes: configuring the WD to perform event A2 measurement in terms of reference signal received quality, RSRQ, or signal to interference and noise ratio, SINR; configuring at least one of an RSRQ threshold and an SINR threshold; configuring one of an RSRQ hysteresis and an SINR hysteresis; and configuring the WD to report event A2. In some embodiments, the method includes configuring the WD to perform channel and interference measurements using non-zero power channel state information-reference signal, CSI-RS, and channel state information-interference measurement, CSI-IM; and configuring the WD to report layer 1 signal to interference and noise ratio, SINR. In some embodiments, the method includes receiving at least one of a measured reference signal received quality, RSRQ, and a signal to interference plus noise ratio (SINR) report from the WD; configuring the NR DMRS with configuration type 2 when the measured one of RSRQ and SINR is smaller than a threshold.

According to another aspect, a network node is configured to communicate with a wireless device, WD. The network node includes processing circuitry configured to configure Type 2 New Radio, NR, demodulation reference signals, DMRSs, for physical downlink shared channel, PDSCH, with DMRS configuration type 2 in a first set of at least one symbol of a time slot, the at least one symbol being a symbol which contains Long Term Evolution, LTE, cell specific reference signals, CRSs. The network node includes a radio interface in communication with the processing circuitry and configured to transmit the NR DMRS with configuration type 2 in the at least one symbol.

According to this aspect, in some embodiments, the processing circuitry is further configured to configure DMRS for PDSCH with mapping type A with DMRS configuration type 2. In some embodiments, the at least one OFDM symbol includes symbols 7 and 11 of the time slot, the time slot having 14 OFDM symbols. In some embodiments, the at least one OFDM symbol includes symbol 8 of the time slot when the LTE CRS has 4 ports and there are three additional DMRS positions, the time slot having 14 OFDM symbols. In some embodiments, the Type 2 NR DMRS and the LTE CRS are transmitted on different subcarriers in the at least one OFDM symbol. In some embodiments, the processing circuitry is further configured to: determine a DMRS code division multiplex, CDM, group that avoids collisions between the NR DMRS configuration type 2 and the LTE CRS; and signal the WD with one or more DMRS ports that belong to the determined DMRS CDM group. In some embodiments the processing circuitry is further configured to: configure the WD to perform event A2 measurement in terms of reference signal received quality, RSRQ, or signal to interference and noise ratio, SINR; configure at least one of an RSRQ threshold and an SINR threshold; configuring one of an RSRQ hysteresis and an SINR hysteresis; and configure the WD to report event A2. In some embodiments, the processing circuitry is further configured to configure the WD to perform channel and interference measurements using non-zero power channel state information-reference signal, CSI-RS, and channel state information-interference measurement, CSI-IM; and configured the WD to report layer 1 signal to interference and noise ratio, SINR. In some embodiments, the processing circuitry is further configured to receive at least one of a measured reference signal received quality, RSRQ, and a signal to interference plus noise ratio (SINR) report from the WD; and configure the NR DMRS with configuration type 2 when the measured one of RSRQ and SINR is smaller than a threshold.

According to yet another aspect, a method in a wireless device, WD, configured to communicate with a network node, includes: determining a first interference estimation on resource elements of New Radio, NR, demodulation reference signal, DMRS, with configuration type 2 in a first symbol which does not contain from Long Term Evolution, LTE, cell specific reference signals, CRS; demodulating and decoding a physical downlink shared channel, PDSCH, on resource elements in OFDM symbols that are used by LTE CRS based on the first interference estimation.

According to this aspect, in some embodiments, the method includes determining a second interference estimation on resource elements of NR DMRS with configuration type 2 in a second symbol in which interference from LTE CRS cannot be detected by the WD; and demodulating and decoding a physical downlink shared channel, PDSCH, on resource elements in OFDM symbols that are not used by LTE CRS based on the second interference estimation.

According to another aspect, a wireless device, WD, is configured to communicate with a network node. The wireless device includes circuitry configured to: determine a first interference estimation on resource elements of New Radio, NR, demodulation reference signal, DMRS, with configuration type 2 in a first symbol in which interference from Long Term Evolution, LTE, cell specific reference signals, CRS, can be detected by the WD; and demodulate and decode a physical downlink shared channel, PDSCH, on resource elements in OFDM symbols that are used by LTE CRS based on the first interference estimation.

According to this aspect, the processing circuitry is further configured to: determine a second interference estimation on resource elements of NR DMRS with configuration type 2 in a second symbol in which interference from LTE CRS cannot be detected by the WD; and demodulate and decode a physical downlink shared channel, PDSCH, on resource elements in OFDM symbols that are not used by LTE CRS based on the second interference estimation.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is illustrates one option of spectrum sharing;

FIG. 2 shows the single-symbol DMRS in configuration type 1 and configuration type 2;

FIG. 3 is a schematic diagram of an example network architecture illustrating a communication system connected via an intermediate network to a host computer according to the principles in the present disclosure;

FIG. 4 is a block diagram of a host computer communicating via a network node with a wireless device over an at least partially wireless connection according to some embodiments of the present disclosure;

FIG. 5 is a flowchart illustrating example methods implemented in a communication system including a host computer, a network node and a wireless device for executing a client application at a wireless device according to some embodiments of the present disclosure;

FIG. 6 is a flowchart illustrating example methods implemented in a communication system including a host computer, a network node and a wireless device for receiving user data at a wireless device according to some embodiments of the present disclosure;

FIG. 7 is a flowchart illustrating example methods implemented in a communication system including a host computer, a network node and a wireless device for receiving user data from the wireless device at a host computer according to some embodiments of the present disclosure;

FIG. 8 is a flowchart illustrating example methods implemented in a communication system including a host computer, a network node and a wireless device for receiving user data at a host computer according to some embodiments of the present disclosure;

FIG. 9 is a flowchart of an example process in a network node for improved New Radio (NR) downlink (DL) interference estimation for spectrum sharing;

FIG. 10 is a flowchart of an example process in a wireless device for improved New Radio (NR) downlink (DL) interference estimation for spectrum sharing; and

FIG. 11 illustrates that there are at least 4 REs in each symbol with DMRS that are not used for LTE CRS or NR DMRS.

### DETAILED DESCRIPTION

Before describing in detail example embodiments, it is noted that the embodiments reside primarily in combinations of apparatus components and processing steps related to improved New Radio (NR) downlink (DL) interference estimation for spectrum sharing. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein may be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

The term “network node” used herein may be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein may be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device, etc.

Also, in some embodiments the generic term “radio network node” is used. It may be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, may be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments provide improved New Radio (NR) downlink (DL) interference estimation for spectrum sharing.

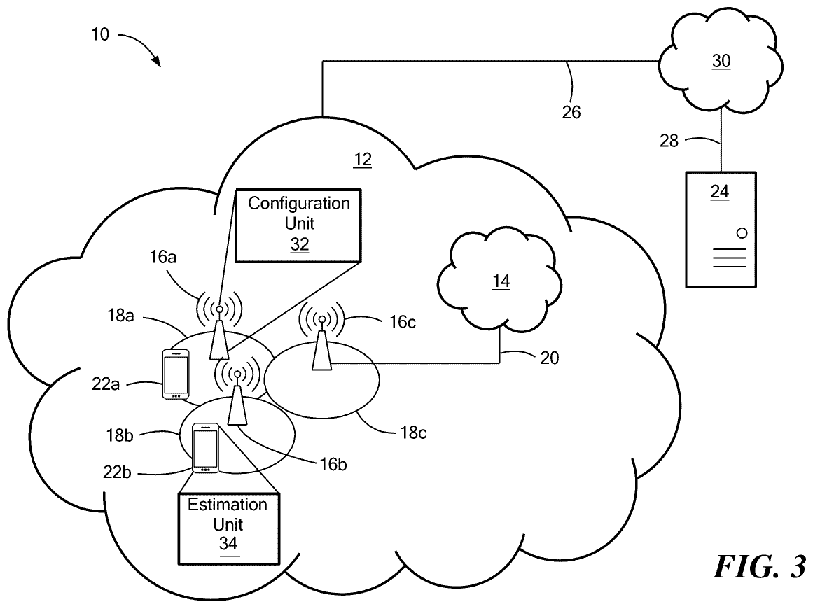

Referring again to the drawing figures, in which like elements are referred to by like reference numerals, there is shown in FIG. 3 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 may be in simultaneous communication and/or configured to separately communicate with more than one network node 16 and more than one type of network node 16. For example, a WD 22 may have dual connectivity with a network node 16 that supports LTE and the same or a different network node 16 that supports NR. As an example, WD 22 may be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

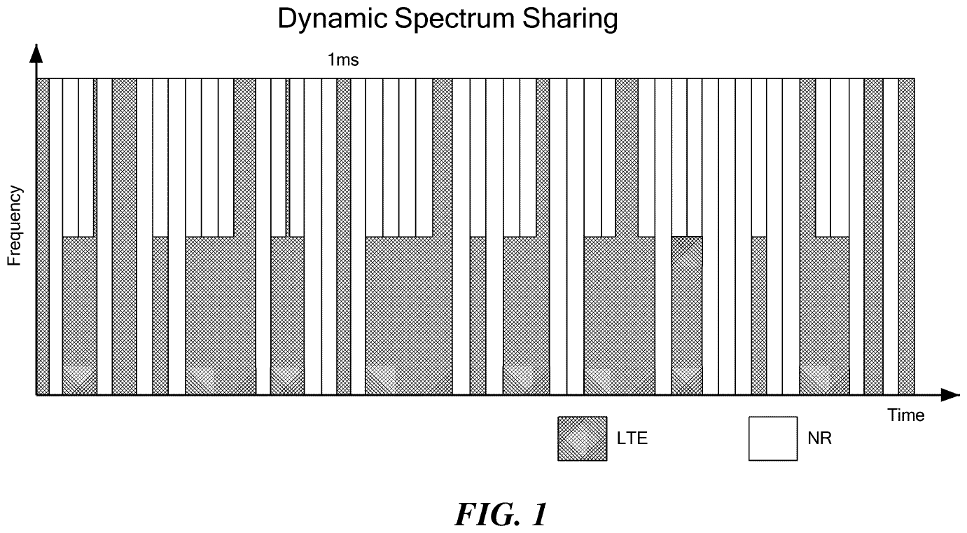

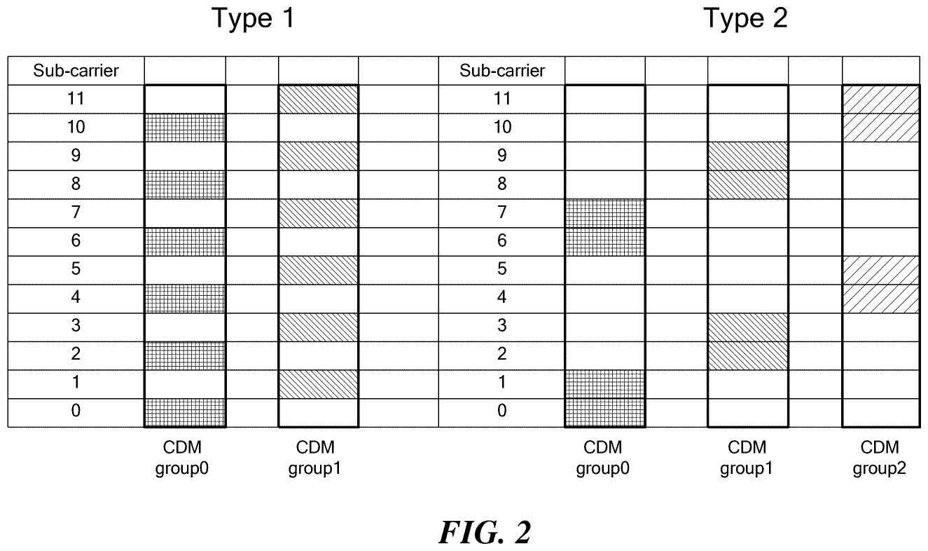

The communication system of FIG. 1 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include a configuration unit 32 which is configured to configure New Radio, NR, demodulation reference signals, DMRSs, for physical downlink shared channel, PDSCH, with DMRS configuration type 2 in a first set of at least one orthogonal frequency division multiplexing, OFDM, symbol of a time slot, the at least one OFDM symbol being a symbol for which Long Term Evolution, LTE, cell specific reference signals, CRSs, can be detected by the WD. A WD 22 is configured to include an estimation unit 34 which is configured to determine a first interference estimation on resource elements of New Radio, NR, demodulation reference signal, DMRS, with configuration type 2 in a first symbol in which interference from Long Term Evolution, LTE, cell specific reference signals, CRS, can be detected by the WD.

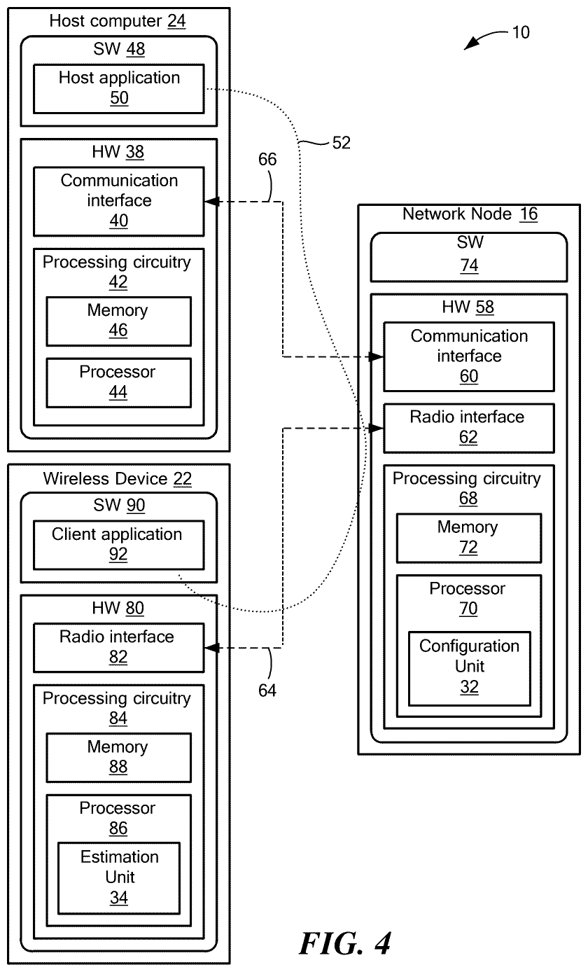

Example implementations, in accordance with an embodiment, of the WD 22, network node 16 and host computer 24 discussed in the preceding paragraphs will now be described with reference to FIG. 4. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include a configuration unit 32 which is configured to configure New Radio, NR, demodulation reference signals, DMRSs, for physical downlink shared channel, PDSCH, with DMRS configuration type 2 in a first set of at least one orthogonal frequency division multiplexing, OFDM, symbol of a time slot, the at least one OFDM symbol being a symbol for which Long Term Evolution, LTE, cell specific reference signals, CRSs, can be detected by the WD.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include an estimation unit 34 which is configured to determine a first interference estimation on resource elements of New Radio, NR, demodulation reference signal, DMRS, with configuration type 2 in a first symbol in which interference from Long Term Evolution, LTE, cell specific reference signals, CRS, can be detected by the WD.

In some embodiments, the inner workings of the network node 16, WD 22, and host computer 24 may be as shown in FIG. 4 and independently, the surrounding network topology may be that of FIG. 3.

In FIG. 4, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 3 and 4 show various “units” such as configuration unit 32, and estimation unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

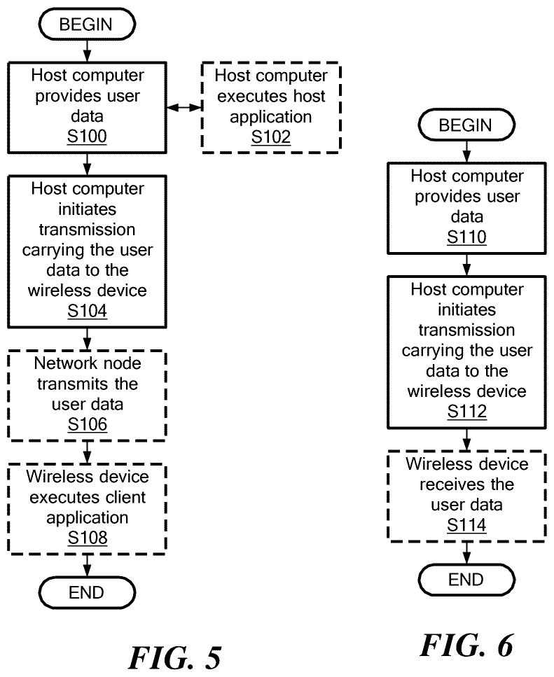

FIG. 5 is a flowchart illustrating an example method implemented in a communication system, such as, for example, the communication system of FIGS. 3 and 4, in accordance with one embodiment. The communication system may include a host computer 24, a network node 16 and a WD 22, which may be those described with reference to FIG. 4. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 6 is a flowchart illustrating an example method implemented in a communication system, such as, for example, the communication system of FIG. 3, in accordance with one embodiment. The communication system may include a host computer 24, a network node 16 and a WD 22, which may be those described with reference to FIGS. 3 and 4. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

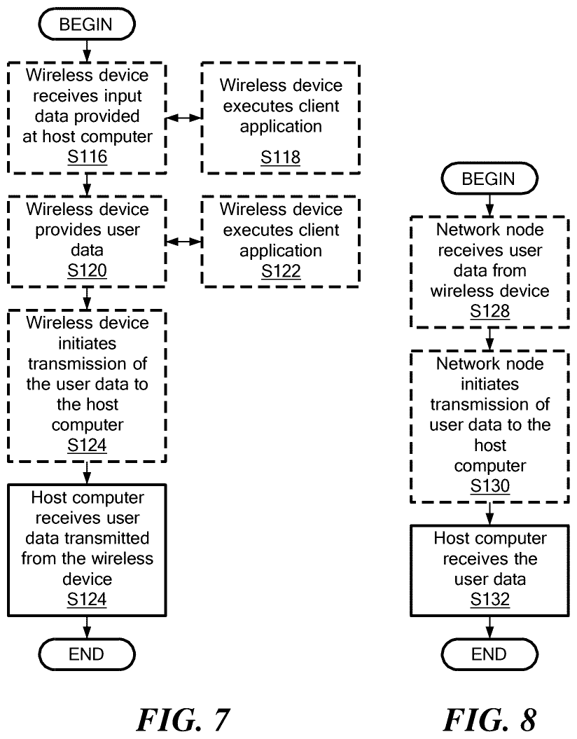

FIG. 7 is a flowchart illustrating an example method implemented in a communication system, such as, for example, the communication system of FIG. 3, in accordance with one embodiment. The communication system may include a host computer 24, a network node 16 and a WD 22, which may be those described with reference to FIGS. 3 and 4. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 8 is a flowchart illustrating an example method implemented in a communication system, such as, for example, the communication system of FIG. 3, in accordance with one embodiment. The communication system may include a host computer 24, a network node 16 and a WD 22, which may be those described with reference to FIGS. 3 and 4. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

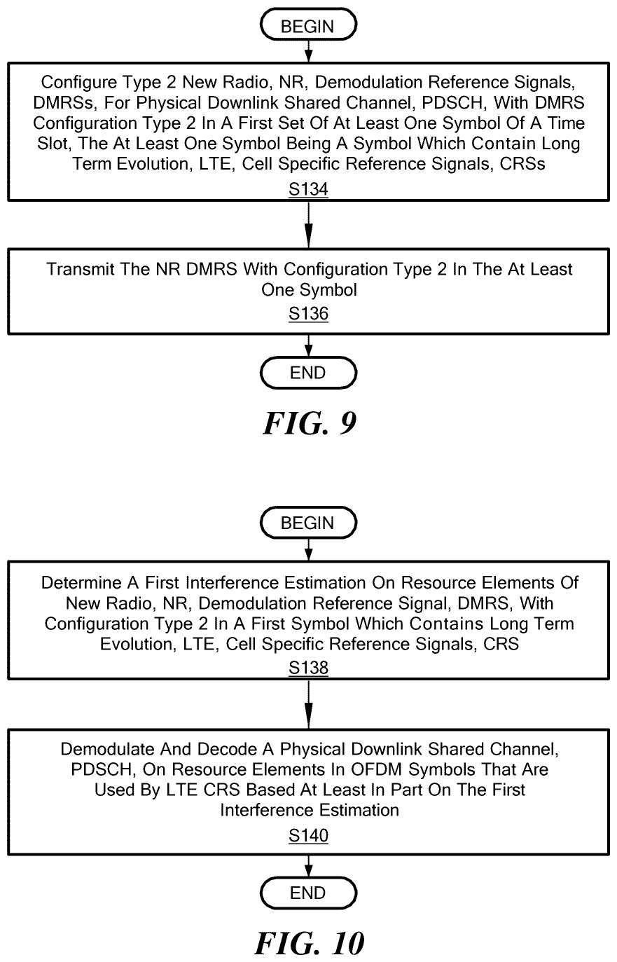

FIG. 9 is a flowchart of an example process in a network node 16 for improved New Radio (NR) downlink (DL) interference estimation for spectrum sharing. One or more blocks described herein may be performed by one or more elements of network node 16 such as by one or more of processing circuitry 68 (including the configuration unit 32), processor 70, radio interface 62 and/or communication interface 60. Network node 16 such as via processing circuitry 68 and/or processor 70 and/or radio interface 62 and/or communication interface 60 is configured to configure New Radio, NR, demodulation reference signals, DMRSs, for physical downlink shared channel, PDSCH, with DMRS configuration type 2 in a first set of at least one orthogonal frequency division multiplexing, OFDM, symbol of a time slot, the at least one OFDM symbol being a symbol which contains Long Term Evolution, LTE, cell specific reference signals, CRSs (Block S134). The method also includes transmitting the NR DMRS with configuration type 2 in the at least one OFDM symbol (Block S136).

In some embodiments, the method includes configuring DMRS for PDSCH with mapping type A with DMRS configuration type 2. In some embodiments, the at least one OFDM symbol includes symbols 7 and 11 of the time slot, the time slot having 14 OFDM symbols. In some embodiments, the at least one OFDM symbol includes symbol 8 of the time slot when the LTE CRS has 4 ports and there are three additional DMRS positions, the time slot having 14 OFDM symbols. In some embodiments, the NR DMRS with configuration type 2 and the LTE CRS are transmitted on different subcarriers in the at least one OFDM symbol. In some embodiments, the method includes: determining a DMRS code division multiplex, CDM, group that avoids collisions between the NR DMRS configuration type 2 and the LTE CRS; and signaling the WD 22 with one or more DMRS ports that belong to the determined DMRS CDM group. In some embodiments, the method includes: configuring the WD 22 to perform event A2 measurement in terms of reference signal received quality, RSRQ, or signal to interference and noise ratio, SINR; configuring at least one of an RSRQ threshold and an SINR threshold; configuring one of an RSRQ hysteresis and an SINR hysteresis; and configuring the WD 22 to report event A2. In some embodiments, the method includes configuring the WD 22 to perform channel and interference measurements using non-zero power channel state information-reference signal, CSI-RS, and channel state information-interference measurement, CSI-IM; and configuring the WD 22 to report layer 1 signal to interference and noise ratio, SINR. In some embodiments, the method includes receiving at least one of a measured reference signal received quality, RSRQ, and a signal to interference plus noise ratio (SINR) report from the WD 22; configuring the NR DMRS with configuration type 2 when the measured one of RSRQ and SINR is smaller than a threshold.

FIG. 10 is a flowchart of an example process in a wireless device 22 according to some embodiments of the present disclosure. One or more blocks described herein may be performed by one or more elements of wireless device 22 such as by one or more of processing circuitry 84 (including the estimation unit 34), processor 86, radio interface 82 and/or communication interface 60. Wireless device 22 such as via processing circuitry 84 and/or processor 86 and/or radio interface 82 is configured to determine a first interference estimation on resource elements of New Radio, NR, demodulation reference signal, DMRS, with configuration type 2 in a first symbol which contains Long Term Evolution, LTE, cell specific reference signals, CRS (Block S138). The process also includes demodulating and decoding a physical downlink shared channel, PDSCH, on resource elements in OFDM symbols that are used by LTE CRS based on the first interference estimation (Block S140).

According to this aspect, in some embodiments, the method includes determining a second interference estimation on resource elements of NR DMRS with configuration type 2 in a second symbol which does not contain LTE CRS; and demodulating and decoding a physical downlink shared channel, PDSCH, on resource elements in OFDM symbols that are not used by LTE CRS based on the second interference estimation. Having described the general process flow of arrangements of the disclosure and having provided examples of hardware and software arrangements for implementing the processes and functions of the disclosure, the sections below provide details and examples of arrangements for New Radio (NR) downlink (DL) interference estimation for spectrum sharing.

An NR PDSCH performance issue may occur when strong interference is mainly from LTE CRS from a neighboring cell. In this case, NR DMRS does not see the interference at all, and the interference estimation based on DMRS may have large error.

One solution to the problem is to allow NR PDSCH DMRS to share with LTE CRS on some OFDM symbols. By doing so, NR DMRS may see interference from a neighbor's LTE CRS and the interference estimation based on DMRS becomes much more accurate. At the same time, NR DMRS should not collide with LTE CRS of the serving cell. When this occur, either NR DMRS or LTE CRS may be punctured, which causes NR or LTE performance degradation.

With NR DMRS configuration type 1, NR DMRS and LTE CRS should not be placed in the same OFDM symbol. When they are in the same symbol, they definitely collide on some resource elements (REs).

In some embodiments, NR DMRS configuration type 2 is used. Even with type 2 DMRS, DMRS configuration should be carefully chosen.

First, NR DMRS and LTE CRS are configured to share some OFDM symbols. Considering NR PDSCH mapping type A, it may be desirable to use all 14 symbols in a physical resource block (PRB). In this case, when no additional DMRS position is configured, the DMRS would be in symbol 3 for spectrum sharing. If one additional DMRS position is configured, NR DMRS would be in symbols 3 and 12. In both cases, NR DMRS and LTE CRS are in different OFDM symbols. If two additional DMRS positions are configured, the NR DMRS may be on symbols 3, 7 and 11. See Table 1, which is table 7.4.1.1.2-3 from 3GPP Technical Standard (TS) 38.211 V16.8.0). Then NR DMRS may share the same symbol with LTE CRS on symbols 7 and 11 whether LTE CRS has 2 or 4 ports.

TABLE 1
PDSCH DM-RS positions l̅ for single-symbol DM-RS.

| | DM-RS positions l̅ | | | | | | | |
|---|---|---|---|---|---|---|---|---|
| | PDSCH mapping type A | | | | PDSCH mapping type B | | | |
| l_{d} in | dmrs-AdditionalPosition | | | | dmrs-AdditionalPosition | | | |
| symbols | pos0 | pos1 | pos2 | pos3 | pos0 | pos1 | pos2 | pos3 |
| 2 | — | — | — | — | l₀ | l₀ | l₀ | l₀ |
| 3 | l₀ | l₀ | l₀ | l₀ | l₀ | l₀ | l₀ | l₀ |
| 4 | l₀ | l₀ | l₀ | l₀ | l₀ | l₀ | l₀ | l₀ |
| 5 | l₀ | l₀ | l₀ | l₀ | l₀ | l_{0, 4} | l_{0, 4} | l_{0, 4} |
| 6 | l₀ | l₀ | l₀ | l₀ | l₀ | l₀, 4 | l_{0, 4} | l_{0, 4} |
| 7 | l₀ | l₀ | l₀ | l₀ | l₀ | l₀, 4 | l_{0, 4} | l_{0, 4} |
| 8 | l₀ | l₀, 7 | l₀, 7 | l₀, 7 | l₀ | l₀, 6 | l_{0, 3}, 6 | l_{0, 3}, 6 |
| 9 | l₀ | l₀, 7 | l₀, 7 | l₀, 7 | l₀ | l_{0, 7} | l₀, 4, 7 | l₀, 4, 7 |
| 10 | l₀ | l₀, 9 | l₀, 6, 9 | l₀, 6, 9 | l₀ | l₀, 7 | l₀, 4, 7 | l₀, 4, 7 |
| 11 | l₀ | l₀, 9 | l₀, 6, 9 | l₀, 6, 9 | l₀ | l₀, 8 | l₀, 4, 8 | l₀, 3, 6, 9 |
| 12 | l₀ | l₀, 9 | l₀, 6, 9 | l₀, 5, 8, 11 | l₀ | l_{0, 9} | l_{0, 5}, 9 | l₀, 3, 6, 9 |
| 13 | l₀ | l₀, l₁ | l₀, 7, 11 | l₀, 5, 8, 11 | l₀ | l_{0, 9} | l_{0, 5}, 9 | l₀, 3, 6, 9 |
| 14 | l₀ | l₀, l₁ | l₀, 7, 11 | l₀, 5, 8, 11 | — | — | — | — |

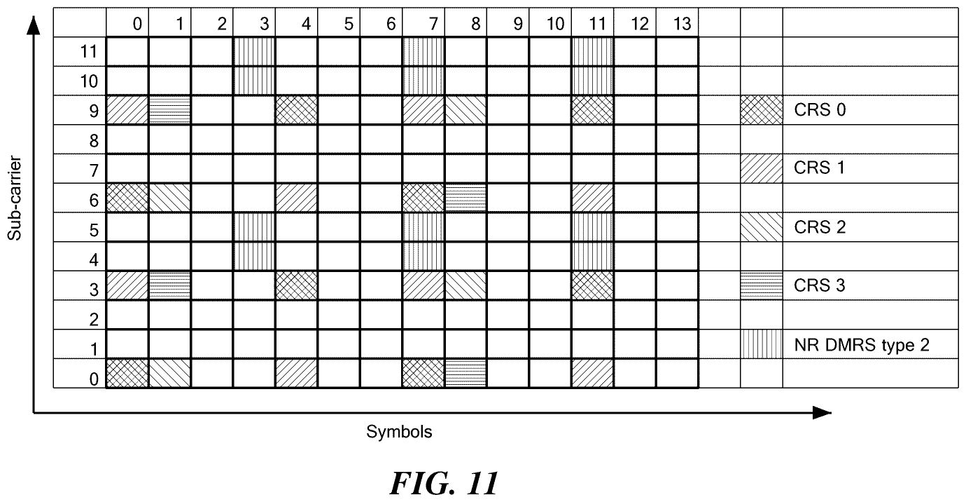

Second, NR DMRS should not collide with LTE CRS of the serving cell. When NR DMRS and LTE CRS are placed in the same OFDM symbols, some embodiments ensure that they use different sub-carriers or resource elements (REs). For a given LTE CRS port, the location of REs is determined by the cell-specific frequency shift depending on the physical cell ID. Assuming 4 CRS ports, there are three possible ways for CRS RE mapping (which REs are used by CRS regardless of the CRS port). For a given CRS RE mapping, DMRS of one CDM group does not collide with the serving cell CRS. For the other two CDM groups, some DMRS REs overlap with LTE CRS REs. Thus, only one CDM group may be allowed in order to avoid collision between NR DMRS and LTE CRS of the serving cell. In FIG. 11, one CDM group of DMRS configuration type 2 doesn't collide with CRS of the serving LTE cell (4-port CRS is shown in FIG. 11).

For a WD 22 that may see strong interference from a neighbor's LTE CRS, the interference may be measured on NR DMRS with the following DMRS configuration:
Type 2; and
Two or three additional positions

For a given LTE physical cell ID, the CRS RE mapping is determined. The NR base station may then determine which DMRS CDM group is allowed. The restriction of one CDM group for the WD 22 may be signaled to the WD 22 through Downlink Control Information (DCI) format 1_1.

FIG. 11 shows that NR DMRS in symbols 7 and 11 may see LTE CRS interference from neighbor cells. But NR DMRS in symbol 3 may not see LTE CRS interference from neighbor cells. But NR DMRS in symbol 3 may see inter-cell interference due to NR and/or LTE traffic. In a scenario where there is not much user traffic in neighbor cells, the WD 22 is able to detect different interference on DMRS in symbol 3 verses DMRS in symbols 7 and 11. Thus, the WD 22 may derive different interference estimation for REs that don't see LTE CRS interference verses REs that do see LTE CRS interference. Eventually, the WD 22 may apply different interference estimation on different REs when demodulating and decoding PDSCH, which may improve PDSCH performance. For example, for demodulation of REs on symbols (e.g. 2, 3, 5, 6, 9, 10, 12 and 13) without CRS present, the Q matrix estimated from symbol 3 may be applied. For demodulation of REs on symbols (e.g. 0, 1, 4, 7, 8 and 11) with CRS on, the Q matrix estimated from symbol 7 and 11 may be applied.

Compared to the conventional DMRS configuration type 1, this DMRS configuration type 2 may have the same overhead with 2 additional DMRS positions. With DMRS configuration type 1 and one additional DMRS position, the minimum overhead per PRB is 12 REs (6 REs per symbol). With DMRS configuration type 2 and two additional DMRS positions, the minimum overhead per PRB is also 12 REs (4 REs per symbol).

The new DMRS configuration allows DMRS power boost, similar to type 1 DMRS. FIG. 11 shows that there are at least 4 REs in each symbol with DMRS that are not used for LTE CRS or NR DMRS. The power on those REs may be used for DMRS power boost.

When the CDM group is restricted for the WD 22, it means the maximum number of PDSCH layer is 2 for the WD 22. However, this may not be a limitation. The maximum number of receive antennas for low band WDs 22 is 2. Even though the NR base station may have a greater number of transmit antennas, the maximum number of layers is 2 (due to the number of WD receive antennas). Mid-band WDs 22 may have more receive antennas. However, for WDs 22 that experience strong inter-cell interference, the number of PDSCH layers is not expected to be greater than 2 most of the time.

In some embodiments, this NR PDSCH DMRS configuration may only be applied to WDs 22 that see strong inter-cell interference in case of spectrum sharing. For other NR WDs 22, the PDSCH DMRS configuration may not be changed.

RSRQ (Reference Signal Received Quality) measurement or SINR (signal to interference plus noise ratio) may be used to identify WDs 22 that may see strong inter-cell interference. For example, measurement event A2 may be configured for all WDs 22. In this case, the WDs 22 are asked to measure RSRQ or SINR. The measured RSRQ or SINR (M) is compared with a configured threshold (Thresh) and a hysteresis parameter (Hys). When a measurement report is received from a WD 22 indicating the condition M+Hys<Thresh is met, the special DMRS may be configured for the WD 22. When a measurement report is received from a WD 22 indicating the condition M−Hys>Thresh is met, the normal DMRS may be configured for the WD 22.

WDs can also be configured to measure layer 1 SINR using NZP CSI-RS (non-zero power channel state information-reference signal) and CSI-IM (channel state information-interference measurements).

If the strong interference is mainly from a neighbor's LTE CRS, the type 2 DMRS configuration allows the WD 22 to obtain much accurate interference estimation from DMRS and to achieve better performance. If the strong interference is from neighbor's LTE CRS and NR/LTE traffic, both configuration type 1 and 2 DMRS may see the interference.

Another option is to use this type 2 DMRS configuration regardless of the interference.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims

1. A method in a network node configured to communicate with a wireless device, WD, the method comprising:
configuring New Radio, NR, demodulation reference signals, DMRSs, for physical downlink shared channel, PDSCH, with DMRS configuration type 2 in a first set of at least one orthogonal frequency division multiplexing, OFDM, symbol of a time slot, the at least one OFDM symbol being a symbol which contains Long Term Evolution, LTE, cell specific reference signals, CRSs; and
transmitting the NR DMRS with configuration type 2 in the at least one OFDM symbol.

2. The method of claim 1, further comprising configuring DMRS for PDSCH with mapping type A with DMRS configuration type 2.

3. The method of claim 1, wherein the at least one OFDM symbol includes symbols 7 and 11 of the time slot, the time slot having 14 OFDM symbols.

4. The method of claim 1, wherein the NR DMRS with configuration type 2 and the LTE CRS are transmitted on different subcarriers in the at least one OFDM symbol.

5. The method of claim 1, further comprising:
determining a DMRS code division multiplex, CDM, group that avoids collisions between the NR DMRS configuration type 2 and the LTE CRS of the serving cell; and
signaling the WD with one or more DMRS ports that belong to the determined DMRS CDM group.

6. The method of claim 1, further comprising:
configuring the WD to perform event A2 measurement in terms of reference signal received quality, RSRQ, or signal to interference and noise ratio, SINR;
configuring at least one of an RSRQ threshold and an SINR threshold;
configuring one of an RSRQ hysteresis and an SINR hysteresis; and
configuring the WD to report event A2.

7. The method of claim 1, further comprising:
configuring the WD to perform channel and interference measurements using non-zero power channel state information-reference signal, CSI-RS, and channel state information-interference measurement, CSI-IM; and
configuring the WD to report layer 1 signal to interference and noise ratio, SINR.

8. The method of claim 1, further comprising:
receiving at least one of a measured reference signal received quality, RSRQ, and a signal to interference plus noise ratio (SINR) report from the WD; and
configuring the NR DMRS with configuration type 2 when the measured one of RSRQ and SINR is smaller than a threshold.

9. A network node configured to communicate with a wireless device, WD, the network node comprising:
processing circuitry configured to configure Type 2 New Radio, NR, demodulation reference signals, DMRSs, for physical downlink shared channel, PDSCH, with DMRS configuration type 2 in a first set of at least one symbol of a time slot, the at least one symbol being a symbol which contains Long Term Evolution, LTE, cell specific reference signals, CRSs; and
a radio interface in communication with the processing circuitry and configured to transmit the NR DMRS with configuration type 2 in the at least one symbol.

10. The network node of claim 9, wherein the processing circuitry is further configured to configure DMRS for PDSCH with mapping type A with DMRS configuration type 2.

11. The network node of claim 9, wherein the at least one OFDM symbol includes symbols 7 and 11 of the time slot, the time slot having 14 OFDM symbols.

12. The network node of claim 9, wherein the Type 2 NR DMRS and the LTE CRS are transmitted on different subcarriers in the at least one OFDM symbol.

13. The network node of claim 9, wherein the processing circuitry is further configured to:
determine a DMRS code division multiplex, CDM, group that avoids collisions between the NR DMRS configuration type 2 and the LTE CRS; and
signal the WD with one or more DMRS ports that belong to the determined DMRS CDM group.

14. The network node of claim 9, wherein the processing circuitry is further configured to:
configure the WD to perform event A2 measurement in terms of reference signal received quality, RSRQ, or signal to interference and noise ratio, SINR;
configure at least one of an RSRQ threshold and an SINR threshold;
configure one of an RSRQ hysteresis and an SINR hysteresis; and
configure the WD to report event A2.

15. The network node of claim 9, wherein the processing circuitry is further configured to:
configure the WD to perform channel and interference measurements using non-zero power channel state information-reference signal, CSI-RS, and channel state information-interference measurement, CSI-IM; and
configure the WD to report layer 1 signal to interference and noise ratio, SINR.

16. The network node of claim 9, wherein the processing circuitry is further configured to:
receive at least one of a measured reference signal received quality, RSRQ, and a signal to interference plus noise ratio (SINR) report from the WD; and
configure the NR DMRS with configuration type 2 when the measured one of RSRQ and SINR is smaller than a threshold.

17-18. (canceled)

19. A wireless device, WD, configured to communicate with a network node, the wireless device comprising processing circuitry configured to:
determine a first interference estimation on resource elements of New Radio, NR, demodulation reference signal, DMRS, with configuration type 2 in a first symbol which contains Long Term Evolution, LTE, cell specific reference signals, CRS; and
demodulate and decode a physical downlink shared channel, PDSCH, on resource elements in OFDM symbols that are used by LTE CRS based at least in part on the first interference estimation.

20. The WD of claim 19, wherein the processing circuitry is further configured to:
determine a second interference estimation on resource elements of NR DMRS with configuration type 2 in a second symbol which does not contain LTE CRS; and
demodulate and decode a physical downlink shared channel, PDSCH, on resource elements in OFDM symbols that are not used by LTE CRS based at least in part on the second interference estimation.
